(19) United States
(12) Patent Application Publication
(10) Pub. No.: US 2009/0108505 A1
(43) Pub. Date: Apr. 30, 2009

(54) BLOW MOULDING MACHINE FOR PLASTIC CONTAINERS, AND METHOD FOR CONTROLLING IT

(75) Inventor: Andreas Steiner, Wenzenbach (DE)

Correspondence Address: MILLS & ONELLO LLP, ELEVEN BEACON STREET, SUITE 605, BOSTON, MA, 02108, US

(73) Assignee: KRONES AG, Neutraubling (DE)

(21) Appl. No.: 12/255,986

(22) Filed: Oct. 22, 2008

(30) Foreign Application Priority Data
Oct. 23, 2007 (DE) 10 2007 050 908.3
Jul. 26, 2008 (DE) 10 2008 034 934.8

(51) Int. Cl. B29C 49/00; B29C 49/28

(52) U.S. Cl. 264/535; 425/144; 425/140; 425/141

(57) ABSTRACT

The invention relates to an apparatus and method for producing containers. The apparatus comprises at least one heating unit which heats preforms; at least one blow moulding unit which expands heated preforms to form containers; at least one sensor device which outputs at least one measured parameter representative of a physical state of the preforms or containers; wherein at least two control parameters of the heating unit or of the blow moulding unit can be varied; and an adjusting unit which is configured in such a way that it adjusts the control parameters as a function of the measured parameter. According to the invention, the adjusting unit comprises an associating device which associates control parameters with predefined measured parameters in a manner that is freely predefinable.

### RELATED APPLICATIONS

This application relies for priority upon German Patent Application No. 10 2007 050 908.3, filed on Oct. 23, 2007, and German Patent Application No. 10 2008 034 934.8, filed on Jul. 26, 2008, the contents of which are herein incorporated by reference in their entirety.

### DESCRIPTION

The present invention relates to a blow moulding machine for blow moulding plastic containers. Such blow moulding machines or arrangements for producing plastic containers are known from the prior art. These arrangements usually comprise a heating section or an oven, within which the preforms are firstly heated. The heated preforms are then expanded, in particular by compressed air, by means of a blow moulding device which comprises a blow mould. Both the oven and also the blow moulding device are controlled on the basis of a plurality of control parameters such as, for example, the temperature, the surface area over which the preforms are heated, a pressure profile for the actual blow moulding operation and the like.

In order to achieve an optimal result, these individual control parameters must be matched to one another as carefully and as accurately as possible. For this purpose, it is known from the prior art that the quality of the containers is checked by a machine operator. If the quality deviates from a certain nominal value, then he himself decides which parameters to change on the blow moulding machine or the heating device. After this change, he again checks the containers and possibly makes further adaptations. For different combinations of preforms and finished containers, often a plurality of different quality criteria have to be monitored and also a plurality of different control parameters have to be controlled or adapted.

A method for the quality control of plastic containers is known from DE 10 2005 044 206 A1. More specifically, said document provides a method for the quality control of a stretch blow moulded plastic container by inspecting its base.

EP 1 175 990 B1 describes an automated control of the material distribution in a stretch blow moulded object. In this method, indicators are applied to the preforms and then, once the container has been expanded, these indicators or the length ratios between these indicators are monitored. The processing units of this stretch blow moulding machine are in turn controlled via a feedback control signal.

WO 2006/087251 A1 describes a method for controlling a container blow moulding machine. In this method, the mass of one region of a container is evaluated, then is compared with a reference mass, and the parameters for the blow moulding operation are adapted in reaction to any changes in mass which are detected.

DE 101 16 665 A1 discloses a method for controlling a blow moulding operation during the production of containers from a thermoplastic material. Here, a wall thickness of the container is detected immediately after the latter has been produced and is compared with a nominal wall thickness. Based on the result of this comparison, at least one blow moulding parameter is changed.

In this method, too, a reaction to a certain change in an actual state compared to a nominal state takes place in a precisely predetermined manner.

In practice, however, many different changes may occur in terms of the container profile, and the machine operator also has a number of options for reacting to a certain container profile.

The object of the present invention is therefore to use control and adjustment possibilities to imitate the behaviour of a machine operator. This is achieved according to the invention by an apparatus for producing containers according to claim 1 and a method for producing containers according to claim 6. Advantageous embodiments and further developments form the subject matter of the dependent claims.

An apparatus according to the invention comprises a heating unit which heats preforms, and also at least one blow moulding unit which expands heated preforms to form containers. Also provided is at least one sensor device which outputs at least one measured parameter representative of a physical state of the preforms or containers. Furthermore, at least two control parameters of the heating unit or of the blow moulding unit can be varied, and the apparatus comprises an adjusting unit which is configured in such a way that it adjusts the control parameters as a function of the measured parameter. According to the invention, the adjusting unit comprises an associating device which associates control parameters with predefined measured parameters, wherein these associations between the measured parameters and the control parameters can be freely predefined.

While fixed adjustment mechanisms are predefined in the prior art, it is possible according to the invention to freely select the parameters for the adaptations. It is thus possible to simulate a situation in which the machine user analyses a container himself and makes corresponding changes to the parameters. The user can in this case even set limit values or parameters, in reaction to which definable control parameters are likewise changed. Preferably, it is not only the measured parameters which are output, but also for example differences or other deviations from respective reference values.

The respective associations may take place for example in the form of a matrix, wherein all the measured parameters are shown in a column and the respective control parameters are shown in the corresponding rows. The reaction that is to take place in response to certain measured parameters or certain variations in measured parameters can be set completely freely by the user. For example, the reaction to an excessively high weight of a base region of the container may be an increased blowing pressure for blow moulding the containers.

A closed control loop in the manner of an electronic platform is thus provided, in which in principle all online measurements or measured parameters of the containers can be combined in a modular manner in a control loop with all the control parameters of the blow moulding machine and optionally also of the oven. For example, a measured value deviation from a certain nominal value can be converted directly into a specific change in a control parameter, optionally after multiplication by a standardisation factor. In this way, it is possible to imitate exactly the behaviour of a machine operator.

To this end, preferably all the quality features which are observed by the machine operator are measured online and quantified.

Furthermore, it is also possible that the sensor devices do not themselves output the measured values directly, but rather only signals from which the measured values can in turn be derived.

As already mentioned, the measured values may also be differences from a reference value. Advantageously, a comparator device is also provided which compares the measured values with reference values and outputs a difference value.

In a further advantageous embodiment, the apparatus comprises a memory device in which associations that have been made can be stored. By virtue of this memory device, changes carried out in the history of the apparatus can be documented and in this way it is possible to establish a control system capable of learning. For example, it is possible to store which measured parameter led to a reaction by which control parameter and in which context. From the subsequent measurements, it is possible to derive whether the use of the control parameter was correct and/or sufficient. When the same measured parameter next deviates, this information can be used as a basis for adapting the control parameter. In this way, the adjustment operations can be carried out very quickly. Such a faster adaptation of the adjustment operations could preferably be carried out by means of a “genetic learning algorithm”.

Preferably, a plurality of sensor devices are provided which output a plurality of measured parameters representative of physical states of the preforms or containers. It is also possible that one sensor device outputs a plurality of such representative measured parameters. Particularly suitable in the case where a plurality of measured parameters are output is an apparatus according to the invention which allows in principle any number of associations between the individual measured parameters and the control parameters. More specifically, with the apparatus according to the invention, in principle all online measurements of the measured parameter relating to the bottles can be combined with a wide range of different control parameters of the blow moulding machine. Furthermore, mean values can also be formed for determining the measured parameters, in order to attenuate a natural scatter. In addition, preferably the number of containers taken into account in each case in the context of determining a measured parameter can also be varied. The cycling of the measured value formation to be carried out in each case can also be defined. Preferably, a standardisation factor is provided, by means of which the dependence between a measured parameter deviation and a change in a control parameter can be set. In this case, the following relationship is obtained:

measured parameter deviation from a nominal value×standardisation factor=change in the control parameter.

Moreover, it is conceivable to limit the ranges within which the control parameters can be varied, so that an adjustment takes place within reasonable values. Furthermore, it is possible to define maximum deviations, beyond which for example production should be interrupted since an automatic adjustment is no longer possible. It is also possible to define the deviations beyond which a certain intervention is to be carried out.

Preferably, the physical states are selected from a group of physical states comprising a height of the container, a weight of a section of the container and in particular of a base of the container, a pressure profile during the blow moulding operation, a wall thickness of the container, a temperature of the preform, a temperature of a mouth of the container, a geometric position of the injection point of the containers, a temperature profile of the preform, optical properties of the container—such as material opacities or the pulling-out of the neck—base freedom, crystallinity, size ratios of the container, degree of stretching, combinations thereof and the like.

Depending on the type of containers and also on the respective users, different physical states of this type may be critical and also different numbers of states. In this preferred embodiment, therefore, the associating device is also freely configurable with regard to the number of measured parameters and the number of control parameters.

In a further advantageous embodiment, the control parameters are selected from a group of control parameters comprising a pre-blowing pressure, an end-of-blowing pressure, a start of pre-blowing, a start of rinsing, a temperature of the preform, a temperature of the wall of a blow mould, a temperature of the mould bottom, the time of a start of rinsing, the pressure profile, the surface cooling of the preform, the mouth cooling of the preform, combinations thereof or the like.

In addition, it is also possible to record individual measured parameters in the form of a profile, for example to record a temperature profile of the preform.

The present invention also relates to a method for producing containers and in particular plastic containers, wherein preforms are heated in a first method step, and in a further method step the preforms are expanded to form containers, and wherein a measured parameter representative of a physical state of the preforms or containers is output by means of at least one sensor device, and wherein at least two control parameters of the heating unit or of a blow moulding unit can be varied, and an adjusting unit adjusts the control parameters as a function of the measured parameters.

According to the invention, an associating unit associates control parameters with predefined measured parameters, wherein these associations between the measured parameters and the control parameters can be freely predefined.

Also according to the invention, therefore, it is possible to simulate a behaviour of a machine user, in which certain reactions to certain deviations from nominal values can be freely predefined.

Preferably, data describing the measured parameters are stored with the associations. For example, it is possible that, in the context of a display request, the user inputs the way in which a certain measured parameter deviates from the nominal value and also the effect that this measured parameter deviation has on a state of the container. Furthermore, the reasons for a change that is to be made can be indicated by the user, and it is possible to specify precisely with which deviations a reaction is to take place in response to the changed measured parameter. These describing data are preferably stored together with the measured parameters and the changed control parameters. In this way, it is possible to achieve a self-learning effect of the apparatus of the method. In this case it is possible to output, in addition to the control parameters, both the output values and also the target values of the control parameters.

Preferably, indications of suitable associations are output. In particular, based on the abovementioned stored data, an indication can be given to the user at a later point in time as to how he can solve a problem that might possibly occur. In this way, an ever-increasing degree of automation can be achieved in the course of operation of the machine based on knowledge that is gradually obtained.

Preferably, tolerance limits can be predefined in addition to the association criteria.

In a further advantageous method, the measured parameters can be logically linked. For example, it is possible to change a certain control parameter in a predefined manner only when both a first measured parameter changes in a certain range and a second measured parameter changes in a likewise predetermined range. Other logic links are also possible, such as in particular OR links, inversions and the like. Accordingly, the control parameters or the variations thereof can also be logically linked. For example, a variance in a measured parameter can be reacted to alternatively or cumulatively by a change in a plurality of control parameters.

Preferably, the measured parameters are deviations from reference values. Preferably, therefore, it is not specific values that are output but rather parameters derived therefrom which represent deviations from reference values. Furthermore, it is also possible to predefine two-stage or multi-stage tolerance limits, for example to specify that no changes will be made as long as the measured parameters deviate from a nominal value by no more than 5%; that certain control parameters will be changed in the case where the measured parameters deviate by between 5% and 15%; and that the machine or apparatus will be stopped in the case where the measured parameters deviate from the nominal value by more than 15%.

Further advantages and embodiments will emerge from the appended drawings:

In the drawings:

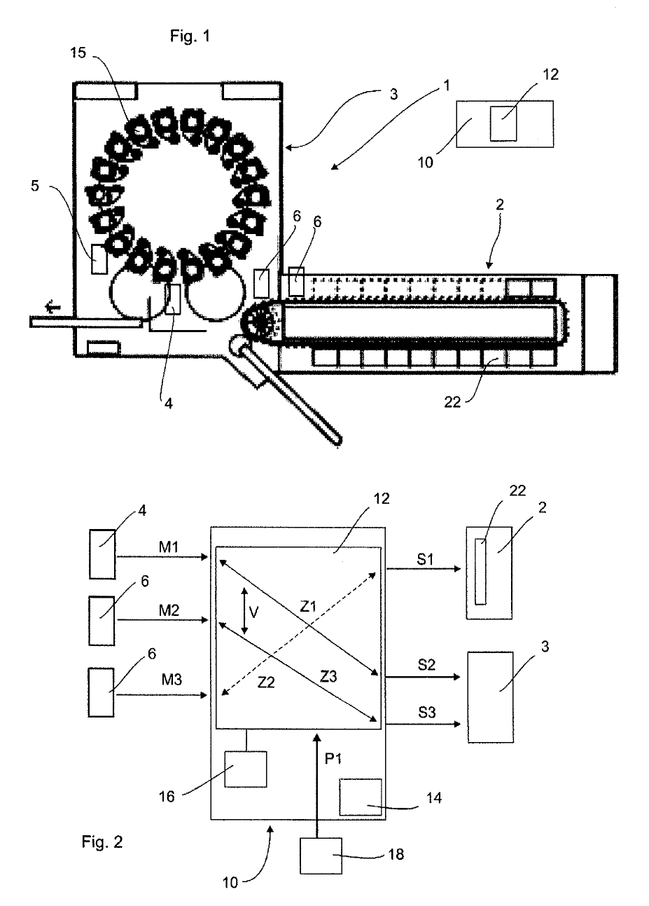

FIG. 1 shows an apparatus according to the invention; and

FIG. 2 shows a detailed view of an adjusting unit according to the invention.

FIG. 1 shows an apparatus 1 according to the invention for producing containers. This apparatus 1 comprises a heating unit 2, such as a conveyor oven, in which the containers are heated. Also provided downstream of this heating unit 2 is a blow moulding unit 3 in which the preforms are expanded to form containers. Preferably, the heating unit 2 and the blow moulding unit 3 are coupled to one another and synchronised.

References 4, 5 and 6 denote various measuring devices which measure certain characteristic physical states of the containers, such as for example a base weight, a wall thickness of the container, a temperature of the preform or the like. It is also possible that these sensor devices 4, 5, 6 record not only characteristic values but rather characteristic profiles, such as the recording of a blowing curve for example. These individual measured parameters are output to an adjusting unit 10.

The adjusting unit 10 is in turn connected to system parts of the apparatus and makes it possible to change various control parameters of the apparatus, such as for example a temperature of the oven 2, a local heating of the preforms within the oven, a cooling for the containers, a surface cooling and the like. Furthermore, the adjusting unit 10 also comprises an associating device 12 which associates the individual control parameters or changes in control parameters to certain measured parameters. Here, the links between the measured parameters and the control parameters, i.e. the conditions under which certain changes in control parameters are carried out, can be freely defined by the user.

Reference 22 denotes a heating device for the heating unit 2, and reference 15 denotes a blow moulding element for the containers. With regard to this blow moulding element 15, various operating parameters or control parameters can be changed, such as for example a pressure profile with which the blow moulding element expands the containers.

FIG. 2 illustrates the mode of operation of the adjusting unit 10. Reference 18 denotes an input unit, by means of which the user can input values or associations into the associating unit 12 and the adjusting unit 10. It may for example be defined beforehand what reaction is to take place in response to a certain change in a measured parameter, i.e. for example a deviation of a base weight by more than 10%. The tolerance limits can also be defined via this input unit 18. Finally, it is also possible for comments to be input via the input device, such as for example the reasons for a certain change in the control values.

Reference 16 denotes a memory device in which changes that have been made by the user and also additional inputs from the user, such as the reasons for a change that has been made, can be stored. Thereafter, it is possible for the adjusting unit 10 to call up firstly the content of the memory device 16 in order to propose certain changes in the control values S1, S2, S3 to the user. The abovementioned reasons for a certain change in the control values can also be read from the memory device 16.

The measured parameters can be output to the user via a display device 14, so that the user can make certain changes in reaction to the displayed measured parameters.

The adjusting unit 10 comprises, as mentioned above, various inputs for measured parameters M1, M2, M3 and also a plurality of outputs for the control parameters S1, S2, S3. Additional, i.e. unoccupied inputs may also be provided in order, if necessary, to retrofit a machine at a later point in time if further sensor devices are available. The same also applies in respect of the outputs of the adjusting unit 10.

The measured parameters M1, M2, M3 are passed from the sensor devices 4, 5, 6 to the adjusting unit 10, and the control parameters S1, S2, S3 are passed from the adjusting unit 10 to the blow moulding unit 3 and/or the heating unit or the operating elements thereof.

In addition, parameters for a mean value formation may also be set, for example how many ratios are to be used to form a mean value and also after how many containers an adjustment is to be carried out.

The associating unit permits any number of associations Z1, Z2, Z3 between the measured parameters M1, M2, M3 and the control parameters S1, S2, S3, wherein these associations Z1, Z2, Z3 preferably also comprise standardisation factors. In principle, it is also possible to form such associations which link together measured parameters and control parameters between which there is no relationship.

Reference V denotes a logic link between individual measured parameters. By virtue of this link, a change in one control value can be made dependent on two logically linked measured values. In addition, a hierarchy or weighting may also be provided between individual measured values, for example the instruction to interrogate a certain measured value after another measured value, or only when the first measured value has a certain result.

All of the features disclosed in the application documents are claimed as essential to the invention in so far as they are novel individually or in combination with respect to the prior art.

1. Apparatus for producing containers, comprising: at least one heating unit which heats preforms; at least one blow moulding unit which expands heated preforms to form containers; at least one sensor device which outputs at least one measured parameter representative of a physical state of the preforms or containers; wherein at least two control parameters of the heating unit or of the blow moulding unit can be varied; and an adjusting unit which is configured in such a way that it adjusts the control parameters as a function of the measured parameter, wherein the adjusting unit comprises an associating device which associates control parameters with predefined measured parameters in a manner that is freely predefinable.

2. Apparatus according to claim 1, wherein the apparatus comprises a memory device in which associations that have been made can be stored.

3. Apparatus according to claim 1, further comprising a plurality of sensor devices which output a plurality of measured parameters representative of physical states of the preforms or containers.

4. Apparatus according to claim 2, wherein the physical states are selected from a group of physical states consisting of a height of the container, a weight of the container, a weight of a base of the container, a pressure profile during the blow moulding operation, a wall thickness of the container, a temperature of the preform, a temperature of a mouth of the container, a geometric position of an injection point of the container, optical properties of the container, size ratios of the container, and combinations thereof.

5. Apparatus according to claim 1, wherein the control parameters are selected from a group of control parameters comprising a pre-blowing pressure, an end-of-blowing pressure, a start of pre-blowing, a start of rinsing, a temperature of the preform, a temperature of the mould wall, a temperature of the mould bottom, the time of a start of rinsing, and combinations thereof.

6. Method for producing containers, comprising: heating preforms at a heating unit; expanding the preforms to form containers at a blow moulding unit, wherein a measured parameter representative of a physical state of the preforms or containers is output by means of at least one sensor device, and wherein at least two control parameters of the heating unit or of the blow moulding unit can be varied, and wherein an adjusting unit adjusts the control parameters as a function of the measured parameters; and further comprising associating the control parameters with predefined measured parameters at an associating unit in a manner that is freely predefinable.

7. Method according to claim 6, further comprising storing associations that have been made in a memory device.

8. Method according to claim 7, wherein data describing the measured parameters are stored with the associations.

9. Method according to claim 6 further comprising outputting indications of suitable associations.

10. Method according to claim 6, wherein tolerance limits can be predefined in addition to the association criteria.

11. Method according to claim 6, wherein the measured parameters can be logically linked.

12. Method according to claim 6, wherein the measured parameters are deviations from reference values.

13. Method according to claim 6, wherein at least some of the measured parameters are stored in a memory device in combination with changes made to the control parameters.

14. Method according to claim 13, wherein the stored combinations are read from the memory device in the context of process control.
